(19) United States
(12) Patent Application Publication
(10) Pub. No.: US 2005/0043095 A1
(43) Pub. Date: Feb. 24, 2005

(54) Apparatus and method for games requiring display of individual player information

(76) Inventor: Lee A. Larson, Katy, TX (US)

Correspondence Address: TEXAS INSTRUMENTS INCORPORATED, P O BOX 655474, M/S 3999, DALLAS, TX, 75265, US

(21) Appl. No.: 10/644,380

(22) Filed: Aug. 20, 2003

(51) Int. Cl. A63F 13/00

(52) U.S. Cl. 463/42

(57) ABSTRACT

Game apparatus includes a display unit, a game hub and at least one game controller. Each console includes a local display unit. The local display unit includes display objects that are typically available only to the user of game controller. For example, in a card game, the display objects would be the cards that had been distributed to the game controller unit. The apparatus on the game controller can be used to select the display object with which the user wishes to continue the game.

### BACKGROUND OF THE INVENTION

1. Field of the Invention

This invention relates generally to the computer games and, more particularly, to computer games that require each player to have access to information that should be unavailable to other players.

2. Background of the Invention

Computer games, games played with data processing apparatus, have become an increasingly important commercial activity. Typically, the multiplayer games have a common displayer screen and the players/users control some aspect of the graphic display. For example, chess can be played by two users or by a user against the program of the game machine.

Referring to FIG. 1, a game configuration, according to the prior art, is shown. The configuration consists or a game hub 10, a display unit 12, and at least one game controller 15. A user participates in the game through the game controller(s) 15. A game controller 15 can include items such as buttons, joy sticks, steering wheels, ball rollers, etc. that permit the user to interact with the game software in predetermined fashion. The game controller 15 transmits signals to the game hub 10 that results in specific interactions with the executing game program. The game program in the game hub 10 integrates the signals from the game controller(s) 15 into display signals that are forwarded to the display unit 12 and provide an image corresponding to the present status of the game program. Based on the present status of the game program, the user(s) can provide response signals through the game controller(s) 15 that advance the current status of the game. The game program permits more than one user to change the current status of the game program and consequently the users can appear, through the image on the display unit, to be interacting with each other. The display unit 12 can be a monitor or a television receiver receptive to signals from the game hub 10 for displaying an image. The game hub 10 includes the logical apparatus for executing the program and for incorporating the inputs from game controller(s) 15 and for the input media for entering the software game programs into the game hubs 10. Typically, the game hub 10 can accommodate a plurality of game controller(s) 15, the type of game controller used depending on the requirements of the game.

A need has therefore been felt for apparatus and an associated method having the feature of providing each user with information not available to other users. It would be another feature of the apparatus and associated method to provide a local display on each game controller. It would be yet another feature of the apparatus and associated method to provide a local display on the game controller displaying information to the user of the game controller not available to other users. It would be a still further feature of the apparatus and associated method to provide a local display on each game controller that displays information necessary for participation in the currently executing game program. It would be a more particular feature of the apparatus and associated method to provide display objects on a local display of a game controller that are determined by the currently execution program and wherein a user can select at least one of the display objects for response by the currently executing program.

### SUMMARY OF THE INVENTION

The aforementioned and other features can be provided, according to the present invention, by a display unit and game hub having at least one game controller coupled thereto. The game hub provides the display unit that displays the current status of the gaming activity and is available to all players. The game controller includes selection apparatus and a local display unit. The display unit of the game controller provides a display of information that is typically available only to the player operating the console. The selection apparatus permits the user to make game choices based on the local display objects. For example, in a card game, the local display unit includes the user's cards (hand). The display unit provides the user with the current status of the card game and the local display unit permits the user to select a card to continue the card game.

Other features and advantages of present invention will be more clearly understood upon reading of the following description and the accompanying drawings and the claims.

### BRIEF DESCRIPTION OF THE DRAWINGS

FIG. 1 illustrates a game configuration according to the prior art.

FIG. 2A illustrates a game configuration according to the present invention, while FIG. 2B is an enlarged view of a game controller according to one implementation of the present invention.

FIG. 3 illustrates an extension of the game controller shown in FIG. 2A wherein the game controller can be remote from the game hub.

### DESCRIPTION OF THE PREFERRED EMBODIMENTS

### 1. Detailed Description of the Figures

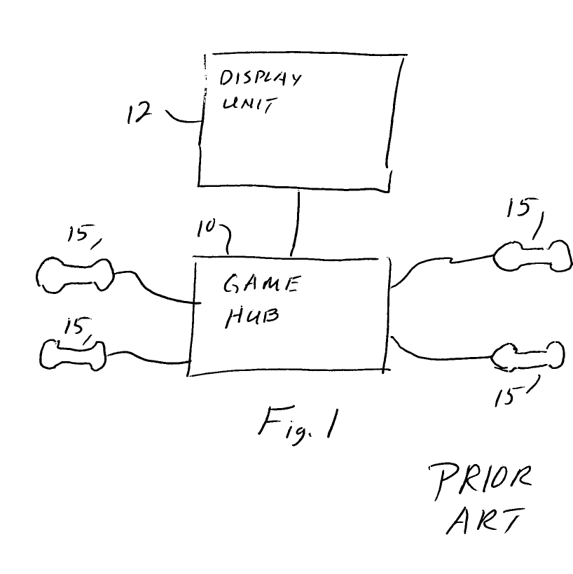

FIG. 1 has been described with respect to the related art.

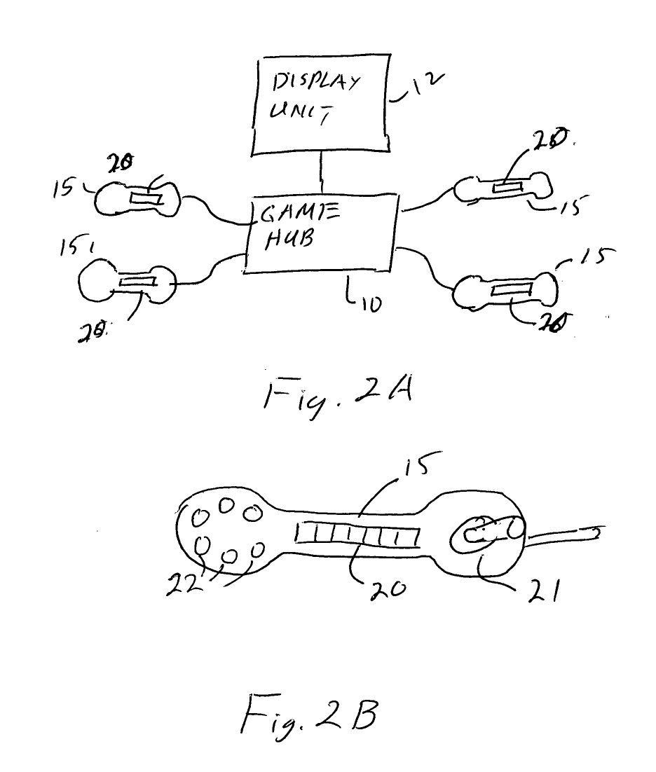

Referring next to FIG. 2A, the apparatus for game playing, according to the present invention, is shown. As in FIG. 1, the game configuration includes a game hub 10, a game display unit 12 coupled to the game hub 10, and at least one game controller 15 coupled to the game hub 10. The game hub 10 includes the apparatus for storing and implementing a game software program. The game hub 10 is adapted to accommodate a plurality of game controller(s) 15. In the present invention, the game controller(s) include a display 20. Typically, the game controller provides input signals to the game hub 10. In the present invention, the local display units 20 on the game controller operate under the control of the program executing in the game hub 10. Therefore, provision must be made to permit signals originating in the game hub 10 to control the display 20 on the game controller 15.

Referring to FIG. 2B, a more detailed view of one possible implementation of the game controller 15 is shown. This game controller 15 includes, in addition to the local display 20, a joy stick controller 21 and a series of buttons 22. The local display unit 20 requires signals from the game hub 10, possibly requiring a redesign of the current game hub and/or the game controller interfaces. The game controller 15 can include more than one joy stick controller and other signal input devices such as steering wheels, switches, ball rollers, etc.

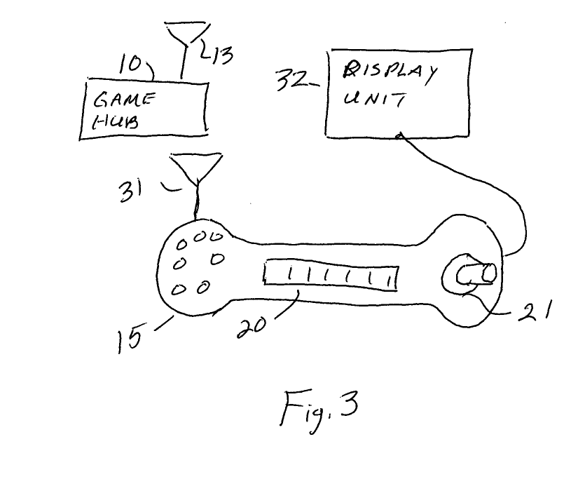

Referring to FIG. 3, a game controller that is remote from the game hub 10 (wherein the game program is executing) is shown. In this implementation, the game hub 10 can transmit signals as illustrated by antenna 13. The game controller 15 can receive the signals transmitted by the antenna 13 on antenna 31. These signals include both the local display signals to be displayed on local display unit 20 and the game status display signals to be displayed on display unit 32. Display unit 32 can be a part of the game controller 32 or can be a coupled monitor or television unit. The used input signals from the game controller 15 can be transmitted to the game hub 10 by means of antennas 31 and 13.

### 2. Operation of the Preferred Embodiment

The operation of the present invention can be understood by consideration of a specific example. In the game of Scrabble, each user is provided with a group of letters and, in accordance with the rules of the game, accumulates points as complete words are formed on a board. Each letter has a value and selected positions that may provide the user with additional points. The display unit provides the status of the game including the letters and accompanying positions for letters that have been played and the accumulated points for each user. The game controller local display shows to the user the letters available for the user to play. When the letter is played, the software program in the game hub makes the relevant adjustments to the display of the display unit and replaces the letters on the game controller display. Note that the present invention differs from prior art game configurations in that the display unit of the game controller must receive signals from the game hub and therefore the operation of the game controller must be integrated with the operation of the game hub.

While the game controller local display has obvious application to card games, Scrabble, dominos and other games where the user/player has materials that are only available to the user/player and that can be selectively entered into the game by the user/player, the local display can provide realism and interest in other games involving strategic considerations. For example, in an auto race, the local controller can provide a display of the gasoline remaining in the tank and amount of wear on the tires. The display of the display unit provides the position of the each user and the distance to complete the race. Because the fueling and the changing of tires require time (the fuel display on the game controller local display requiring time to transfer the fuel into the tank), the players have further strategic considerations that more fully simulate an actual race. Similarly, in games of conflict, because a player could not realistically have an unlimited supply of ammunition or ordinance, the local display can provide an inventory of these items that, not being available to opposing players, result in a more realistic type of game.

One of the big considerations in game apparatus is the cost. The local display on the game controller can be implemented in the relatively inexpensive liquid crystal technology. The size of the display will depend on the particular game being implemented or the situation being simulated. Similarly, relatively inexpensive microprocessors or digital signal processors are available to control the operation of the liquid crystal display.

While the game has been described as being activated by a plurality of players, it will be clear that processing apparatus itself can provide the response of one or more of the players. As indicated by FIG. 3, the game controller can be at a location remote from the game hub.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

1. A game system, the game system having a game program, the system comprising:
at least one game controller, each game controller including apparatus permitting a user to generate user input signals, the game controller including a controller display unit, the controller display unit displaying game objects relating to the status of the game program;
a game hub coupled to each game controller, the game hub receiving user input signals and integrating the user input signals in the game program, the game hub generating game controller display signals and status display signals in accordance with a current status of the game program, the game controller display signals being transmitted to the game controller; and
a display unit coupled to the game hub, the display unit displaying an image determined by the status display signals.

2. The system as recited in claim 1, wherein the game controller display signals provide data to the user of the game controller not available to users of other game controller(s).

3. The system as recited in claim 2, wherein the data provided by the game controller display signals permit the user to interact with the game program.

4. The system as recited in claim 1, wherein the game hub and the game controllers are remote from each other.

5. A method of implementing a game program, the method comprising:
transmitting user input signals from a game controller to a game hub, the input signals advancing the game program; and
transmitting status signals from the game hub to the game controller, the status signals providing the user with a status of the game program.

6. The method as recited in claim 5, wherein the status signals provide image objects displayed on a display unit associated with a game controller.

7. The method as recited in claim 6, of image objects assist a user in selecting input signals.

8. The method as recited in claim 7, wherein at least one game controller is remote from the game hub.

9. For use with game apparatus, a game controller interacting with a game program being executed in a game hub, the game controller comprising;
at least one signal input device for generating signals interacting with a game program; and
a display unit for displaying image objects resulting from status signals transmitted from the game program.

10. The game controller as recited in claim 9, wherein the image objects are specific to the game controller user's interaction with the game program.

11. The game controller as recited in claim 10, wherein the image objects displayed by the display unit permit a the game controller's user to interact with the game program.

12. The game controller as recited in claim 11, wherein the game apparatus includes a game hub coupled to the game controller and a status display unit coupled to the game hub, the game program being executed in the game hub, the status display unit displaying the current status of the game program.

13. The game controller as recited in claim 12, wherein the the status signals transmitted by the game hub to the game controller relate only to the interaction of the user of the game controller with the game program.

14. The system as recited in claim 5 wherein transmitting status signals from the game hub to the game controller includes transmitting status signals that are specific to the user of the game controller receiving the status signals.
